(19) United States
(12) Patent Application Publication
(10) Pub. No.: US 2011/0109570 A1
(43) Pub. Date: May 12, 2011

(54) ELECTRONIC MESSAGE BOARD AND USER INTERFACE THEREFOR

(75) Inventors: Naeem Mady, Boca Raton, FL (US); Edmund Mady, Delray Beach, FL (US)

(73) Assignee: Mady Multimedia, Inc., Boca Raton, FL (US)

(21) Appl. No.: 12/846,454

(22) Filed: Jul. 29, 2010

Related U.S. Application Data
(60) Provisional application No. 61/229,581, filed on Jul. 29, 2009.

(51) Int. Cl. G06F 3/041

(52) U.S. Cl. 345/173

(57) ABSTRACT

A multi-user electronic message board includes a touch-sensor display screen and a processor. The processor is configured for organizing, storing and displaying data pertaining to time management of multiple household users, and for organizing, storing and displaying multiple lists of data related to the management of domestic life.

This application claims priority to U.S. Provisional Patent Application No. 61/229,581 filed Jul. 29, 2009, the entire disclosure of which is incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of message boards, and in particular to a user interface for an electronic message board.

### SUMMARY

In one embodiment, the invention provides a user interface for an electronic message board which facilitates household communication, management and organization, with data input via a touch sensor display screen. The device provides a centralized, multi-user organizational tool that can be located in a high-traffic area of a household, for convenient communal use by all household members. The device eases the complex routine of daily life through comprehensive awareness and coordination of everyday activities, thus mitigating conflicts and confusion.

The device provides a means for organizing, storing and displaying data pertaining to the time management of multiple household users, both as a comprehensive schedule and as individual schedules. It can organize, store and display multiple lists of data related to the management of domestic life including, but not limited to important phone numbers, daily and long-term tasks and chores, household shopping needs, pertinent health information for all household members, and inter-family communication through electronic bulletin board and notepad. The device provides a means for organizing, storing and displaying photographic images.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a front elevational view illustrating a message board device in accordance with an embodiment of the invention.

FIG. 2 shows a right side elevational view illustrating a message board device in accordance with the embodiment of FIG. 1.

FIG. 3 shows a rear elevational view illustrating a message board device in accordance with the embodiment of FIG. 1.

FIG. 4 shows a left side elevational view illustrating a message board device in accordance with the embodiment of FIG. 1.

FIG. 5 shows a hardware diagram in accordance with one embodiment of the invention.

FIG. 6A is a front elevational view showing an example of an interface for providing a tagging function.

FIG. 6B is a front elevational view showing an example of an interface for adding an event.

FIG. 6C is a front elevational view showing a further example of an interface for adding an event.

FIG. 7A is a front elevational view showing an interface for triggering a Contact List feature.

FIG. 7B is a front elevational view showing an interface for displaying Contact List information.

FIG. 7C is a front elevational view showing a further interface for displaying Contact List information.

FIG. 8 is a front elevational view showing a To-Do list interface.

FIG. 9 is a front elevational view showing a Notes interface.

FIG. 10 is a front elevational view showing a Health Information interface.

### DETAILED DESCRIPTION

Reference will now be made in detail to the preferred embodiments of the present invention, examples of which are illustrated in the accompanying drawings.

The present invention is described below with reference to block diagrams and operational illustrations of methods and devices to a user interface for an electronic message board. It is understood that each block of the block diagrams or operational illustrations, and combinations of blocks in the block diagrams or operational illustrations, may be implemented by means of analog or digital hardware and computer program instructions. These computer program instructions may be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

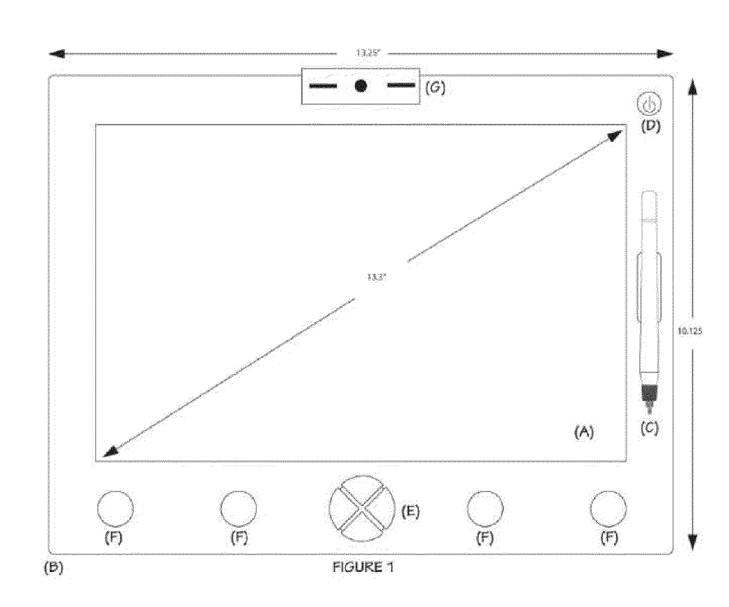

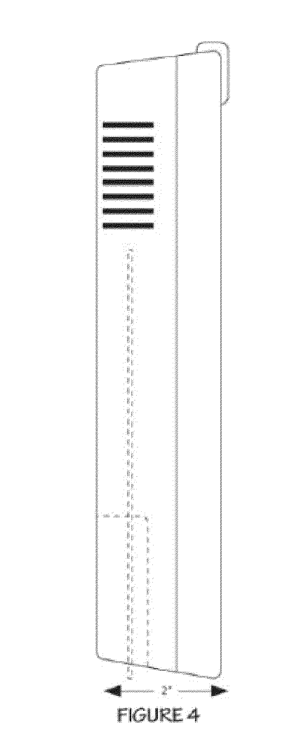

FIGS. 1-4 show an example of a message board device with dimensions of, e.g., 13.25″ W×10.125″ H×2″ D. However, product dimensions and weight can vary.

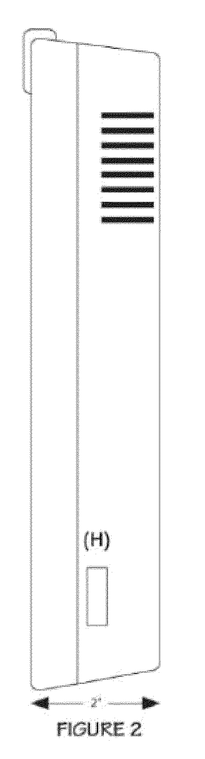

As shown in FIG. 1, in one embodiment the device includes a built-in touch sensor display screen (A), which may be, e.g., a 13.3″ touch sensitive display measuring 11.5″ by 7″, housed in a plastic enclosure (B) that is comprised of plastic and post-consumer recycled material. Information may be input through direct contact to the touch-sensor display, either from contact from user's finger to the screen (A) or Contact with specialized pointer tool /stylus (C). Information may also be input via buttons imbedded in plastic casing, including a power on/off button (D), central four-quadrant home button (E), smaller buttons for specific features (F), and an integrated web camera (G). As shown in FIG. 2, an integrated universal serial bus (“USB”) port (H) may be provided.

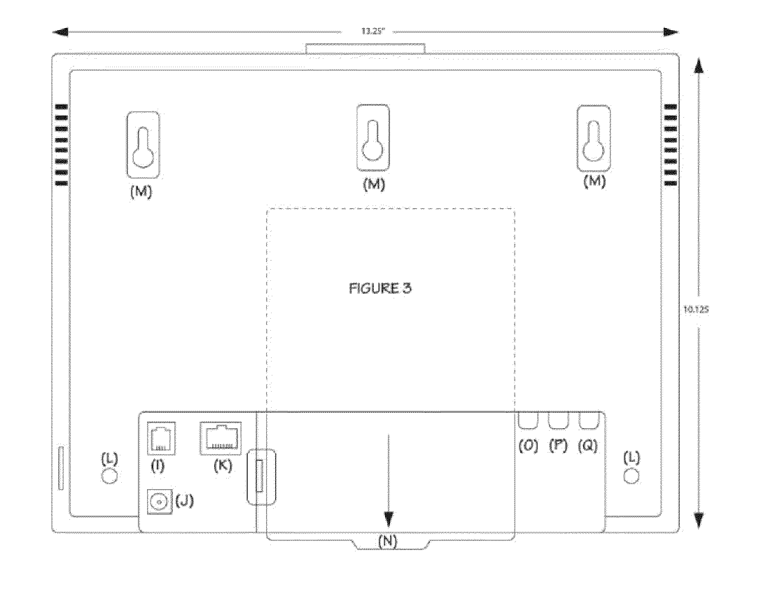

With reference to FIG. 3, in an embodiment of the device, a 4-pin RJ-11 port (I) is included for expanded usage capabilities through additional modules, such as security and monitoring systems. An internal battery is provided, and may be recharged through DC jack (J). An internal wireless internet connection device, as well as built-in Ethernet port (K), are provided. Stabilizers (L) may be provided.

The device has the ability to be mounted, either vertically or horizontally, to a wall or other surface including a household refrigerator, using the attached wall mount points (M). The wall-mount embodiment includes an auxiliary pull-down surface (N), made from cork board material, for the additional storage and display of printed photos or paper. The device includes built-in Video (O) and Audio (left (P) and right (Q)) inputs for expanded usage capabilities.

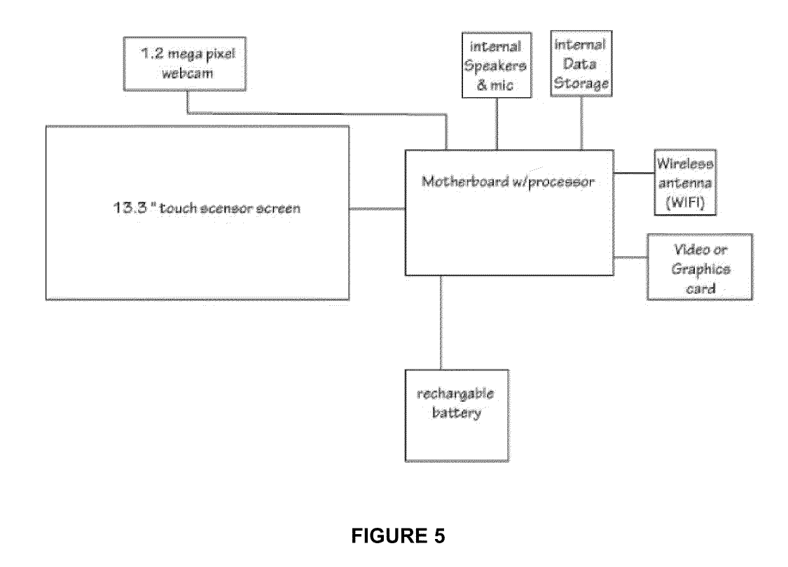

FIG. 5 shows a hardware diagram illustrating an example of a hardware configuration of the device.

User data input is controlled via a touchscreen interface. The touchscreen provides input via stylus or finger touch. Users may ‘write’ on the touchscreen to create characters, or may use the stylus in the same manner. An on-screen keyboard provides an alternative touch interface. The stylus provides an additional feature: the ability to erase by using the reverse end of the stylus. This feature allows the user to simply drag the stylus over any detail view and remove information exactly as one would with a pencil, by lightly scrubbing the text.

The software backend for the device can be an open-source Linux AMP distribution which stores and presents a local HTML based user interface. AMP devices provide the following. An Apache HTTP Server accepts HTTP requests from clients (user agents such as web browsers), and serves them HTTP responses along with optional data contents, which usually are web pages such as HTML documents and linked objects (images, etc.). This will be used to store base elements of the user interface. This will include icons, graphics and static text. A MySQL database, which is a relational database management system, is provided for storing, organizing and retrieving variable data input. Stored data will consist of appointments, contact list, to-do list, etc. A PHP compiler provides an “interactive experience” that is termed “dynamic”. Content (text, images, form fields, etc.) on a web page can change in response to different contexts or conditions. Using the backend LAMP, the user interface will be provided with the capability of providing instant updates to the family's data.

Creation of modules can be done with a simple and familiar web site “look and feel”. The user interface may be a locally viewed dynamic website, with reading and writing to an internal database.

Each display vertical is preferably separated into three interface areas. The leftmost area is for user input sections (adding notes, contacts) or search features. The center area is always associated with personal data (friend contacts, personal schedule, to-do). The right section always a general overview of family data available to all users.

A Family Unit provides the user with the ability to input a family organizational tree. This user group will directly tie into ‘contacts’ as a pre-existing group. Each family member can be given a color code or icon to be readily identifiable in other software modules. From the main Family Screen, a user can instantly retrieve their schedule, see a list of personal contacts, or quick view any items tagged to their attention.

The interface may include a Tagging feature in which every vertical data set inherently contains a ‘tagging’ option. These tags will be used to alert a family member of association with an event/contact/to-do/etc. These tagging buttons will expand dynamically to include all family members. Multiple tags can be applied to an entry. Each tag can have a favorite color or icon associated for quick view options. Colors and icons will be consistent throughout the device when applied. For example: any event, contact, to-do, health detail, etc. can show up with a background color and/or icon that matches the family member profile selection.

The device in one embodiment presents the user with a home screen and five information verticals. These verticals consist of Schedule, Contacts, To-Do, Notes, and Health information. Each area has a unique dataset presented to the user in a format that is easy to view, add and update. Each of these five verticals are described below.

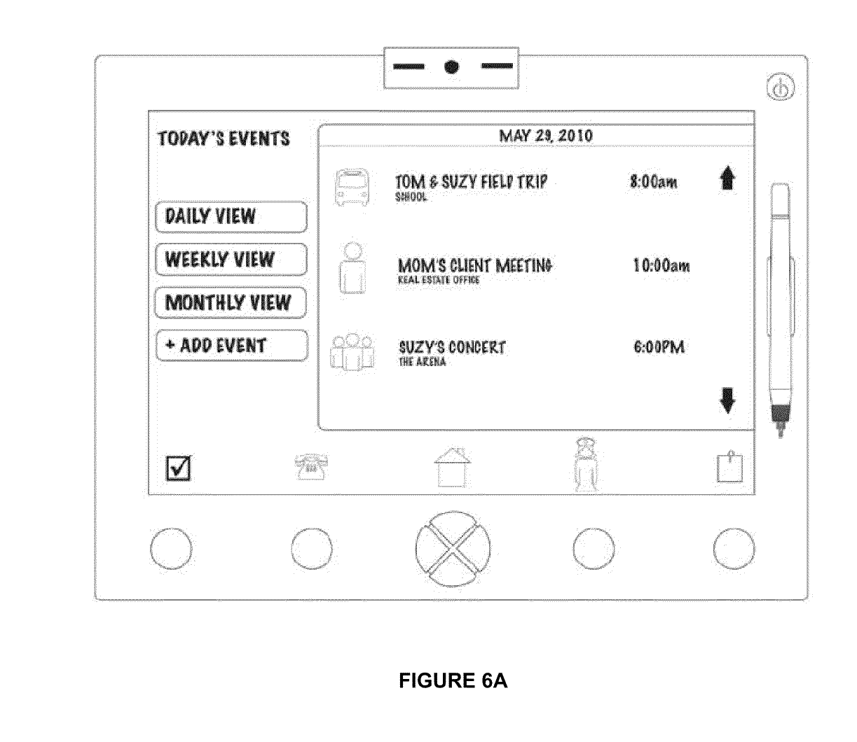

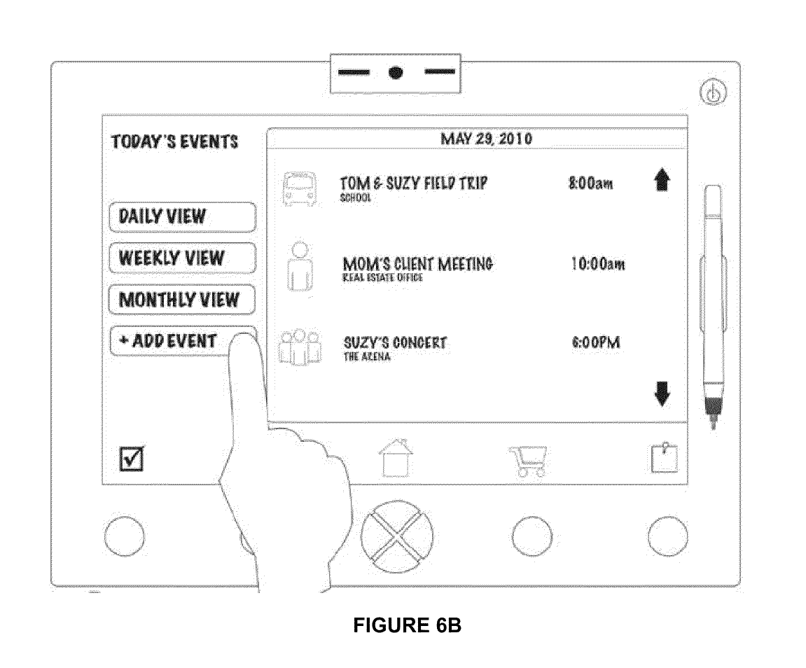

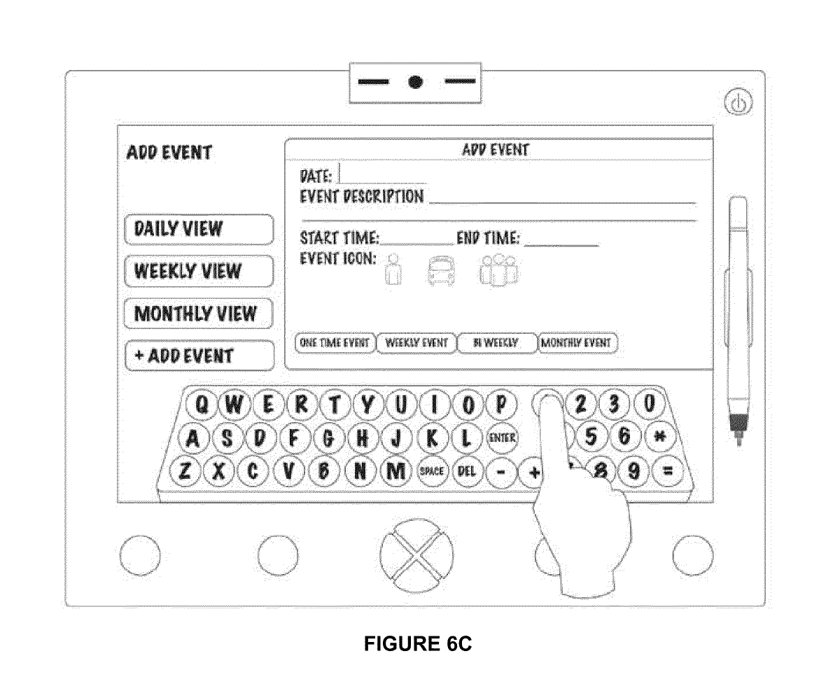

Schedule: At the heart of the scheduler is each user's daily list: a running log of events with start-time, end-time and location, all “tagged” to individual or multiple family members (FIG. 6A). These data points will be compiled to generate a nested overview of the family schedule, capable of being zoomed to gain a micro or macro view of the busy lives of a family.

Daily View: The default view of the scheduler is a daily view of the family's activities. The daily view is a vertically scrolling list, showing time, location and family member involved in the activity. This list is organized by time, but can be quickly switched to be organized by family members, displayed in side by side lists. The user may get a closer look at one particular family member's daily list by clicking on that family member's icon.

Weekly View: The week view is a horizontal view broken into a 7-day boxed view. This view highlights activities by listing family member's icons next to events, and each event also is designated by a ‘tick or star’ next to the icon. Each daily box is contained in this weekly overview without text, only iconography. The user may click on any day's box and change to that day's daily view, as described above.

Monthly View: The monthly view displays a standard calendar view for the current month. Activities are displayed by a grouping of ‘ticks or stars’ in each day's square. These ‘ticks’ will be color coded to represent the family members with an activity on that particular day. From the monthly view, the user may select a specific week to get more details of that week's activities.

With reference to FIG. 6B, an ever present “Add Event” button is available on any scheduler screen. Touching this icon will pull up the “add new event window” shown in FIG. 6C. Users can enter a new event and “tag” it to a family member by the simple process of touching a pop-out calendar, selecting a date, touching a pop-out clock to input start and end times, text input of location, and touching a family member icon to attach this event to their calendar.

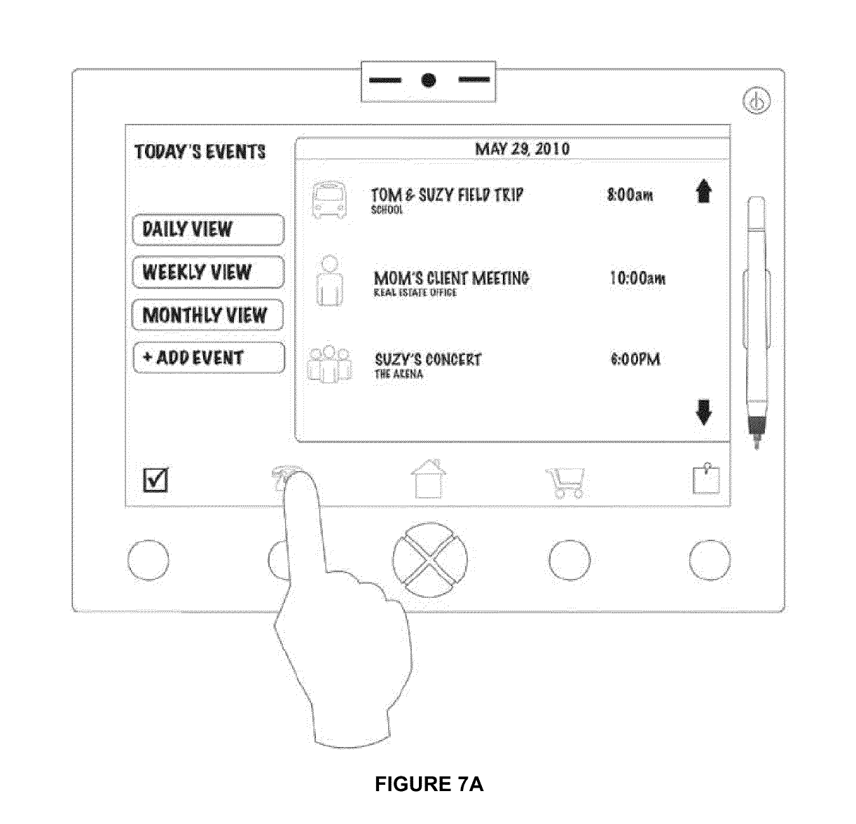

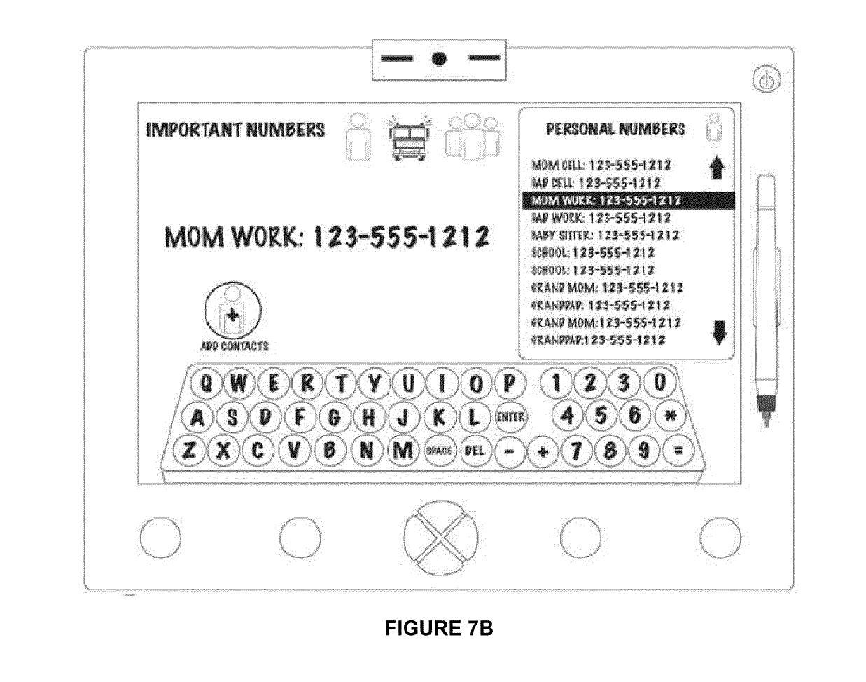

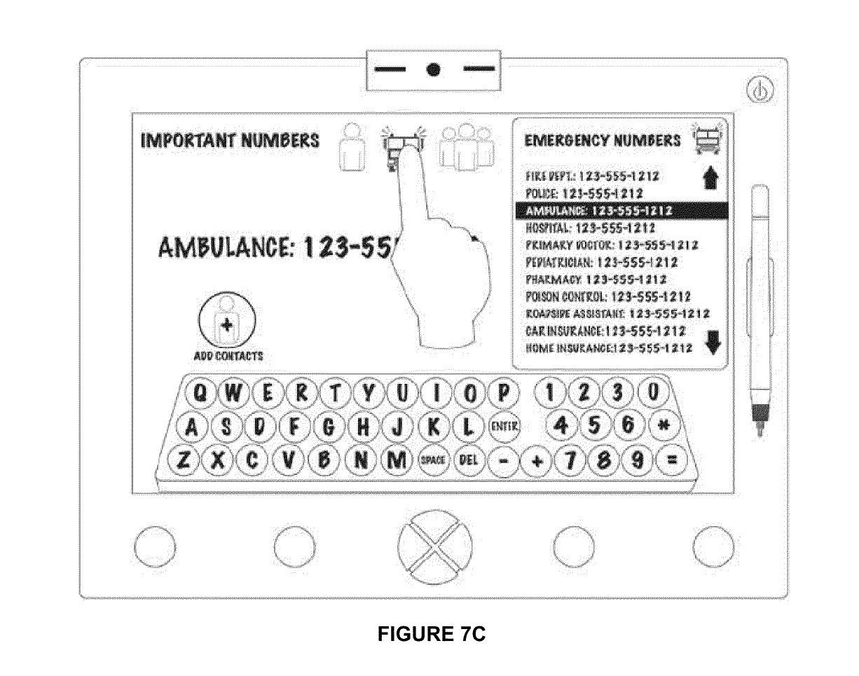

As shown in FIG. 7A, the user can touch the icon of a telephone at the bottom of the screen to open a Contact List. As shown in FIG. 7B, the user is presented with a quick list of contact names and phone numbers in a list view. The default list will consist of contacts that are tagged to the current user. Examples are Coaches, Teachers, Friends, Relatives, etc. These contacts have specifically been ‘tagged’ to the current user. Additional lists can be retrieved for display using a set of icons that represent various groups (FIG. 7C). These lists are the same across all users. For example, touching the “flame” icon will display a list of emergency phone numbers for local fire/rescue, and touching the “stethoscope” icon will reveal doctor, hospital, and health contacts.

Multi-item lists are scrollable via touching an arrow on the side of the list or by pulling/pushing the list with a finger swipe. To sort the user will simply click one of the column headings. An input area for quickly adding new numbers and a smart search section is shown on the initial contacts screen. The smart search sorts through all numbers stored on the device and auto-completes based on partial input of title, name, connection. For example, entering “DR” in the search will begin listing any names with the search string, as well as any Family Doctor connections. For detailed information on any contact, the user can double tap the contact information to show a close-up, contact card view. This will provide for additional phone numbers, mailing address, email address, etc.

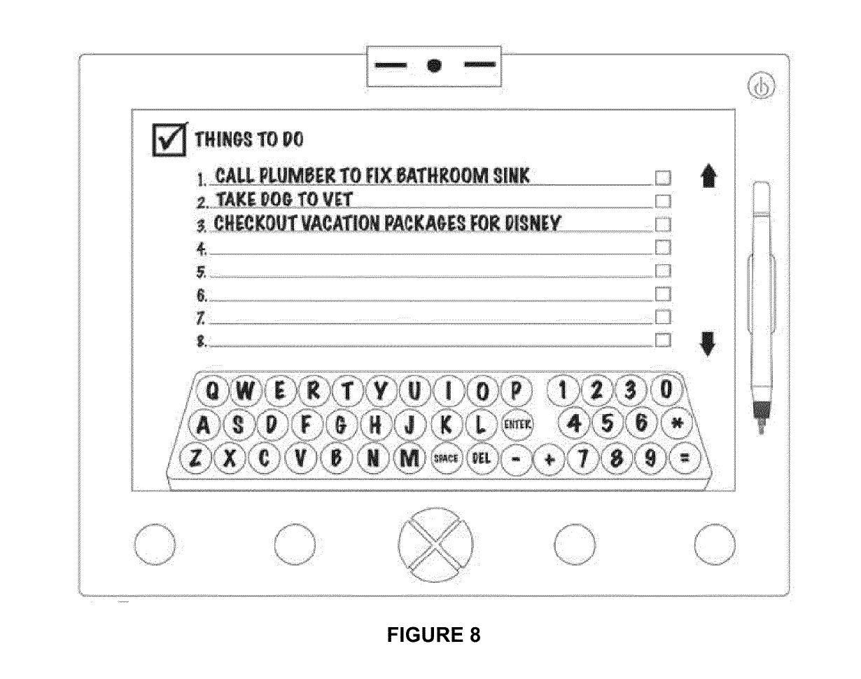

With reference to FIG. 8, a To-Do feature may also be provided. This feature is similar to the scheduler, but without a date reference. The To-Do screen provides a list of chores or to-do's around the home. A tally list of tasks will be presented in list format with a check box to signify completion when touched. An input area is available on this screen to add a new task to the list. As with any module, these tasks can be tagged to specific family members.

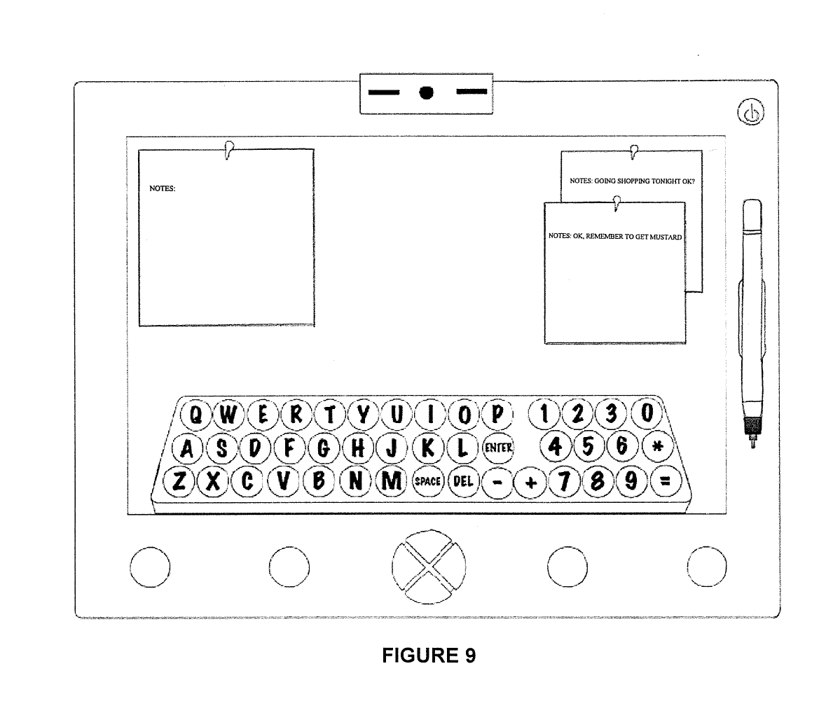

As illustrated in FIG. 9, a Notes feature may also be provided. The interface consists of a selection of on-screen ‘sticky’ style notes. This area provides for quick posted information between family members, as well as self-reminders. Each posted note contains the summary information, can be tagged to specific family members, and contain follow up posts by other users. The background color of the notes is selectable by the user, with each note being capable of displaying a different background color. The touchscreen interface allows notes to be moved freely around the screen. Notes can be stacked on top of each other as needed. Users can auto arrange notes using a double-tap motion directly on the screen to retrieve a simple menu. This menu allows the user to sort by color or tag. Users enter note data into a ‘blank’ note on the left side of the screen. By default, the note is ‘tagged’ to the entering user and can be ‘tagged’ to fellow family members/users individually or as a whole family/group. Each note contain a follow-along thread for responses from other family members/users. Each user of the family group has their tagged notes displayed in the center of the screen. These notes are scrollable with a finger drag in a downward motion, revealing the next note. Whole family notes are displayed in a sidebar. Any note can be double tapped to reveal a zoomed, full screen mode for detailed viewing or input.

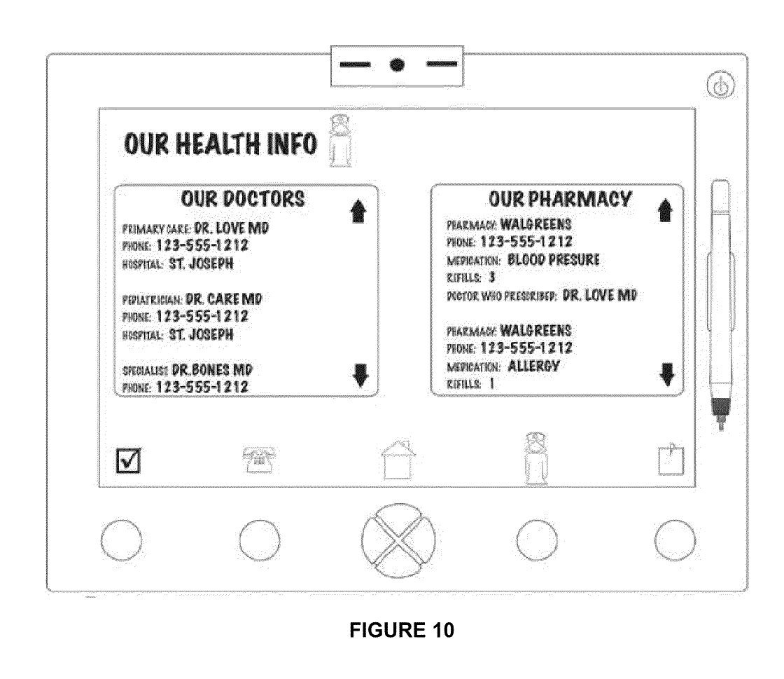

With reference to FIG. 10, a Health Information feature may be provided. This vertical contains a quick view of each family member's doctors, specialists and hospital contacts. This view also shows upcoming doctor's appointments, medications currently prescribed (or OTC), along with a schedule of daily dosage. The quick view shows the prescribing doctor's phone number. A user is able to zoom into a medication and view exact information on the medication along with side-effects and warnings. A history of the prescription can be stored in the detail screen listing the start date and history of dosage.

While the invention has been particularly shown and described with reference to a preferred embodiment thereof, it will be understood by those skilled in the art that various changes in form and details may be made therein without departing from the spirit and scope of the invention. For example, the device and interface described herein may be adapted for college dormitories and small businesses, as a centralized electronic communication and organizational management display tool.

1. A multi-user electronic message board, comprising:
a touch-sensor display screen;
a processor configured for organizing, storing and displaying data pertaining to time management of multiple household users, and for organizing, storing and displaying multiple lists of data related to the management of domestic life.

2. The multi-user electronic message board according to claim 1, wherein said lists if data comprise at least one list selected from the set consisting of: important phone numbers, daily and long-term tasks and chores, household shopping needs, pertinent health information for all household members, and inter-family communication through electronic bulletin board and notepad.

3. The multi-user electronic message board according to claim 1, wherein said processor is further configured for organizing, storing and displaying photographic images.
